(19) United States
(12) Patent Application Publication
(10) Pub. No.: US 2008/0228291 A1
(43) Pub. Date: Sep. 18, 2008

(54) SYSTEM AND METHOD FOR ENERGY SAVING FUNCTIONALITY

(75) Inventors: Michael Hubo, Hattingen (DE); Daniel Bencak, Dortmund (DE)

Correspondence Address: MORGAN & FINNEGAN, L.L.P., 3 WORLD FINANCIAL CENTER, NEW YORK, NY, 10281-2101, US

(73) Assignee: NOKIA CORPORATION, Espoo (FI)

(21) Appl. No.: 11/685,977

(22) Filed: Mar. 14, 2007

(51) Int. Cl. G05B 13/02

(52) U.S. Cl. 700/40

(57) ABSTRACT

Systems and methods applicable, for example, in energy saving functionality. A host device and a connected device might, for instance, exchange data within an instance of an activity period. The host device might, for example, send a request to the connected device. The host device and/or the connected device might, for instance, terminate and/or place hardware into one or more reduced energy consumption modes. Such termination might, for example, allow for data exchange during a subsequent activity period instance.

### FIELD OF INVENTION

This invention relates to systems and methods for energy saving functionality.

### BACKGROUND INFORMATION

In recent times, there has been an increase in users becoming concerned about energy use by devices (e.g., wireless nodes and/or other computers, and/or peripheral devices).

For example, many users have eagerly adopted the use of devices that are portable and/or that possess their own energy sources but, for instance, have been disappointed by the amount of time that they can use the devices after charging them. As another example, many users have increasingly come to possess environmental and/or political motivations for conserving energy.

Accordingly, there may be interest in technologies that facilitate energy savings.

### SUMMARY OF THE INVENTION

According to embodiments of the present invention, there are provided systems and methods applicable, for example, in energy saving functionality.

A host device and a connected device might, in various embodiments, exchange data within an instance of an activity period. In various embodiments, the host device might send a request to the connected device.

The host device and/or the connected device might, in various embodiments, terminate and/or place hardware into one or more reduced energy consumption modes.

Such termination might, in various embodiments, allow for data exchange during a subsequent activity period instance.

### BRIEF DESCRIPTION OF THE DRAWINGS

FIG. 1 shows exemplary request aspects involving affirmative connected device response according to various embodiments of the present invention.

FIG. 2 shows exemplary request aspects involving negative connected device response according to various embodiments of the present invention.

FIG. 3 shows exemplary data exchange aspects and exemplary reduced energy consumption mode aspects according to various embodiments of the present invention.

FIG. 4 shows an exemplary computer.

FIG. 5 shows a further exemplary computer.

### DETAILED DESCRIPTION OF THE INVENTION

### General Operation

According to embodiments of the present invention, there are provided systems and methods applicable, for example, in energy saving functionality.

A host device might, according to various embodiments, send a request (e.g., a Universal Serial Bus (USB) vendor-specific request) to a connected device. Included in the request might, in various embodiments, be an activity period specification. The host device might, in various embodiments, receive a response to the request.

In various embodiments, the host device and the connected device might exchange data (e.g., via USB) within an instance of the activity period. Such data exchange might, in various embodiments, involve periodic and/or non-periodic transfer.

The host device and/or the connected device might, in various embodiments, place hardware into one or more reduced energy consumption modes. Such reduced energy consumption modes might, in various embodiments, take place within the activity period instance.

The host device and/or the connected device might, in various embodiments, terminate the one or more reduced energy consumption modes. Such termination might, in various embodiments, allow for data exchange during a subsequent activity period instance.

One or more resume signals might, in various embodiments, be sent (e.g., from the host device to the connected device).

Various aspects of the present invention will now be discussed in greater detail.

### Setup Operation

According to various embodiments of the present invention, a host device might send a request to a connected device. The host device and/or the connected device might, for instance, be a wireless node and/or other computer, and/or a peripheral device. The peripheral device might, for instance, be a storage device, an input device, and/or an output device.

For example, such a peripheral device might be an audio output device (e.g., a headset, a speaker, and/or a device offering output to an audio device), a video output device (e.g., a display and/or a device offering output to a display), an audio input device (e.g., a microphone and/or a device accepting input from an audio device), a video input device (e.g., a camera and/or a device accepting input from a video source), a positioning device (e.g., Global Positioning System (GPS) device), a networking device, flash memory, and/or a hard disk. The host device and/or the connected device might, in various embodiments, be a portable device and/or a device possessing its own energy source (e.g., one or more batteries and/or fuel cells). Via various functionality discussed herein, the host device and/or the connected device might, in various embodiments, come to enjoy energy savings and/or benefits related thereto (e.g., an increase in the amount of time that the device can be used on a single charge).

The host device might, as an illustrative example, be a wireless node and the connected device might be a peripheral device. The host device and the connected device might, for example, be connected via USB.

Included in the request might, for instance, be an activity period specification. The activity period specification might, for example, be expressed as one or more durations of time (e.g., the activity period specification might indicate 3 ms) and/or in terms of communication functionality (e.g., the activity period specification might indicate three frames).

The request might be sent to the connected device in a number of ways. For example, the request might be sent as a vendor-specific request, as configuration data, and/or along with data to be exchanged between the host device and the connected device (e.g., in response to user and/or software request). The vendor-specific request might, for instance, be a USB vendor-specific request (e.g., a USB 2.0 vendor-specific request). The vendor-specific request might, for example, include RequestType, bRequest, wValue, wIndex, and/or wLength specification.

Such a RequestType specification might, for instance, indicate direction (e.g., connected device to host device), type (e.g., vendor), and/or recipient (e.g., connected device). Such a bRequest specification might, for instance, indicate the request purpose (e.g., request relating to activity period). Such a wValue specification might, for instance, express activity period (e.g., as one or more time durations and/or in terms of communication functionality). Such a wLength specification might, for instance, indicate that no further data is to be transferred in the data stage, and/or that the connected device should respond with a null packet in the status stage if it understands the request or a stall if it does not. As an illustrative example, the vendor-specific request might include:

RequestType: 0xC0

bRequest: 0xB1

wValue: 0x0005

wIndex: 0x0000

wLength: 0x0000

The connected device might, for example, send to the host device a response to the request. In various embodiments, in the case where the connected device supports the request (e.g., where the connected device supports the vendor-specific request) and/or supports the activity period specification, the connected device might provide an affirmative response to the host device. Such an affirmative response might, for instance, be sent during a status stage (e.g., during a status stage of a corresponding vendor-specific request). Such an affirmative response might, for example, involve the connected device sending certain information (e.g., a null packet) to the host device.

In various embodiments, in the case where the connected device does not support the request and/or does not support the activity period specification, the connected device might provide a negative response to the host device. Such a negative response might, for instance, be sent during a status stage (e.g., during a status stage of a corresponding vendor-specific request). Such a negative response might, for example, involve the connected device sending certain information (e.g., a stall packet) to the host device.

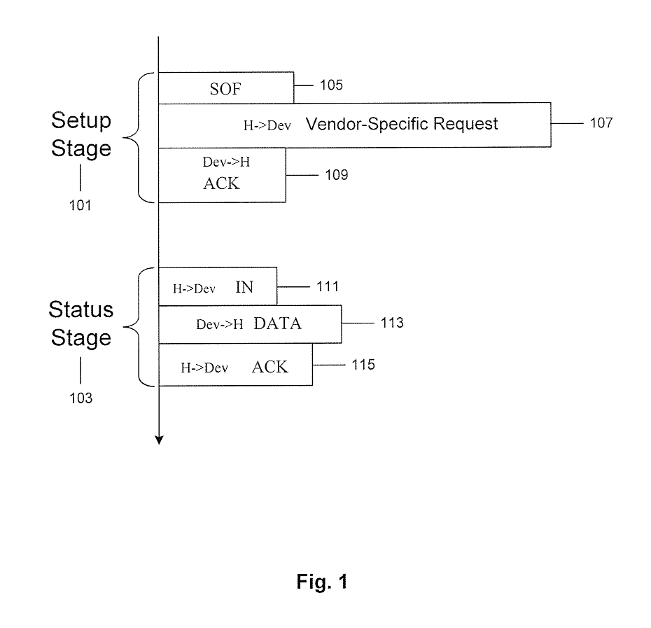

FIG. 1 shows exemplary request aspects involving affirmative connected device response according to various embodiments of the present invention. Depicted, for instance, in FIG. 1 are setup stage 101, status stage 103, start of frame (SOF) 105, vendor-specific request 107 (from the host device to the connected device), acknowledgement (ACK) 109 (from the connected device to the host device), IN token 111 (from the host device to the connected device), affirmative response 113 (from the connected device to the host device), and ACK 115 (from the host device to the connected device).

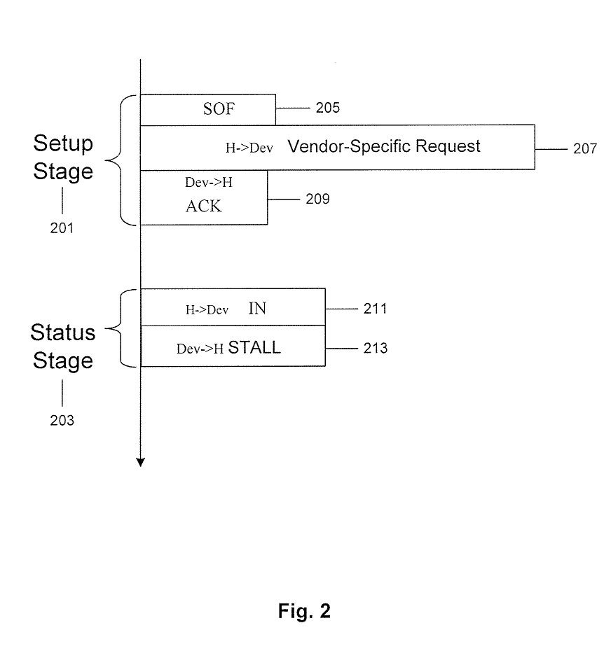

FIG. 2 shows exemplary request aspects involving negative connected device response according to various embodiments of the present invention. Depicted, for instance, in FIG. 2 are setup stage 201, status stage 203, SOF 205, vendor-specific request 207 (from the host device to the connected device), ACK 209 (from the connected device to the host device), IN token 211 (from the host device to the connected device), and stall packet 213 (from the connected device to the host device).

With respect to various functionality discussed herein it is noted that, in various embodiments, the host device and the connected device might switch roles such that, for instance, the device that had been considered to be the host device comes to be considered to be the connected device, and/or that the device that had been considered to be the connected device comes to be considered to be the host device. USB On-The-Go (OTG) might, in various embodiments, be employed. It is additionally noted that, in various embodiments, various operations discussed herein as being performed by a host device might be performed by a connected device, and/or various operations discussed herein as being performed by a connected device might be performed by a host device. It is further that, in various embodiments, employed USB might be USB 2.0.

### Data Exchange Operation

The host device and the connected device might, in various embodiments, exchange data within activity period instances. As an illustrative example, in the case of a 5 ms activity period, commencing with a particular point in time an activity period instance might commence every 5 ms. Such data exchange might, in various embodiments, occur subsequent to the connected device providing an affirmative response (e.g., of the sort discussed above).

The host device and/or the connected device might, for instance, make use of clocks. For example, each of the host device and/or the connected device might make use of its own independent clock. A clock employed by the host device and/or a clock employed the connected device might, for instance, be integrated into and/or in communication with it.

For example, the host device might, via use of its clock, learn that an activity period instance is and/or will soon be commencing. Alternately or additionally, the connected device might, for example, via use of its clock learn that an activity period instance is and/or will soon be commencing.

In various embodiments, the host device and/or the connected device might not have its own clock. A resume signal might be sent, for instance, under such circumstances (e.g., via USB). The resume signal might, for instance, be sent prior to the start of a subsequent activity period instance by a particular duration of time and/or with respect to communication functionality. For example, the resume signal might sent be sent 1 ms prior to the start of a subsequent activity period instance, and/or one frame (e.g., one USB frame) prior to the start of a subsequent activity period instance. It is noted that, in various embodiments, the resume signal might not be associated with USB standard suspend-resume functionality.

As an example, in the case where the host device has its own clock but the connected device does not, the host device might send a resume signal to the connected device. The host device might, for instance, send such a signal subsequent to learning, perhaps as discussed above, that an activity period instance is and/or will soon be commencing.

As another example, in the case where the connected device has its own clock but the host device does not, the connected device might send a resume signal to the host device. The connected device might, for instance, send such a signal subsequent to learning, perhaps as discussed above, that an activity period instance is and/or will soon be commencing.

As yet another example, in the case where neither the host device nor the connected device has its own clock, the host device and/or the connected device might receive a resume signal from a third device, the third device perhaps learning in a manner analogous to that discussed above that an activity period instance is and/or will soon be commencing.

It is noted that, in various embodiments, clock drift (e.g., between a clock of the host device and a clock of the connected device) might be taken into account. For example, such clock drift might determine choice of activity period, and/or a chosen activity period might dictate how much clock drift is acceptable. As another example, resume signaling might be employed in view of clock drift (e.g., in the case where clock drift is found to be unacceptable). For instance, in the case where both the host device and the connected devices have their own clocks, but clock drift is found to be unacceptable, a resume signal might, perhaps in a manner analogous to that discussed above, be sent from the host device to the connected device, from the connected device to the host device, and/or from a third device to the host device and/or to the connected device.

Having learned from its clock and/or having received a resume signal, the host device might, for instance, commence data exchange with the connected device. Alternately or additionally, the connected device might, for instance, commence data exchange (e.g., via USB) with the host device.

Such data exchange might, for instance involve periodic and/or non-periodic transfer. Such periodic transfer might, for instance, involve streaming data (e.g., audio and/or video) and/or the use of audio and/or video input and/or output devices (e.g., the use of a headset and/or a microphone).

Data exchange involving non-periodic transfer might, in various embodiments, be employed in the case where bandwidth is considered to be a less important factor. Such might, for instance, be the case where one or more networks are considered to be limiting factors, and/or in the case where data exchange involves browsing (e.g., World Wide Web browsing). Such circumstances might, for example, arise in the case where a host device employs a modem and/or other networking device as a connected device.

It is noted that, in various embodiments, data exchange might involve the use of isochronous transfers and/or interrupt transfers. It is additionally noted that, in various embodiments, isochronous transfers and/or interrupt transfers may complete within one frame (e.g., one USB frame).

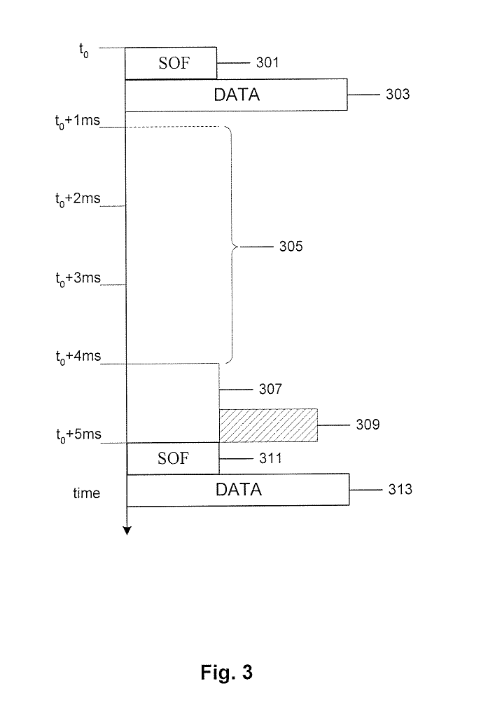

Shown, for example in FIG. 3 are exemplary data exchange aspects according to various embodiments of the present invention. Depicted, for instance, in FIG. 3 are SOF 301 and data 303.

### Reduced Energy Consumption Mode Placement Operation

According to various embodiments of the present invention, the host device and/or the connected device might place hardware into one or more reduced energy consumption modes. The host device and/or the connected device might perform such action, for instance, within activity period instances and/or subsequent to completion of data exchange (e.g., data exchange of the sort discussed herein).

The hardware placed into one or more reduced energy consumption modes by the host device and/or the connected device might, for instance include USB communication hardware and/or other communication hardware. For example, one or more transceivers (e.g., USB transceivers), one or more controllers (e.g., device and/or host controllers such as, for instance, USB device and/or host controllers), one or more bus drivers, and/or one or more microcontrollers and/or other processors might be placed into the one or more reduced energy consumption modes. Such microcontrollers and/or other processors might, for instance, handle USB and/or other communications.

It is noted that, in various embodiments, during the one or more reduced energy consumption modes, energy use by the host device and/or by the connected device (e.g., via USB VBUS) might be, and/or might be permitted to be, higher than one or more particular energy use levels. For instance, such energy use might be, and/or might be permitted to be, higher than one or more suspend mode energy levels (e.g., USB suspend mode levels). For example, greater than 2.5 mA might be drawn. Such energy use might serve a number of purposes. For instance, such energy use might be employed by a connected device in playback of received audio and/or video data (e.g., last received audio and/or video data). It is noted that, in various embodiments, energy used by the connected device might be provided by the host device, and/or energy used by the host device might be provided by the connected device. It is further noted that, in various embodiments, the one or more reduced energy consumption modes might not be suspend modes (e.g., the one or more reduced energy consumption modes might not be USB suspend modes). It is additionally noted that, in various embodiments, the host device and/or the connected device might act to ensure that no data will be sent and/or received while in the one or more reduced energy consumption modes.

Turning again to FIG. 3, it is noted that shown, for example, in FIG. 3 are exemplary reduced energy consumption mode aspects according to various embodiments of the present invention including, for instance, placement 305 of host device and connected device hardware into one or more reduced energy consumption modes.

It is noted that, in various embodiments, occurring within a particular activity period instance may be data exchange between the host device and the connected device, the host device and/or the connected device placing hardware into one or more reduced energy consumption modes, and/or the host device and/or the connected device terminating one or more reduced energy consumption modes.

### Reduced Energy Consumption Mode Termination Operation

According to various embodiments, the host device and/or the connected device might terminate one or more reduced energy consumption modes (e.g., one or more reduced energy consumption modes of the sort discussed above). Such termination might, for instance, take place within a current activity period instance and/or might allow for data exchange during a subsequent activity period instance.

The termination might, for instance, be performed in accordance with the activity period. For example, each of the host device and/or the connected device might make use of its own independent clock in such termination. As another example, each of the host device and/or the connected device might make use of a received resume signal in such termination.

For example, the host device might, via use of its clock, learn that a subsequent activity period instance is and/or will soon be commencing. Alternately or additionally, the connected device might, for example, via use of its clock learn that a subsequent activity period instance is and/or will soon be commencing.

Having so learned from its clock, the host device and/or the connected device might terminate one or more reduced energy consumption modes. For instance, communication hardware (e.g., of the sort discussed above) might be withdrawn from one or more previously entered reduced energy consumption modes. Alternately or additionally, the host device and/or the connected device might, for instance, dispatch (e.g., via USB) one or more resume signals.

For example, the host device might send such a resume signal to the connected device and/or the connected device might send such a resume signal to the host device. It is noted that, in various embodiments, a third device might send such a resume signal to the host device and/or to the connected device. The resume signal might, for instance, be sent prior to the start of a subsequent activity period instance by a particular duration of time and/or with respect to communication functionality. For example, the resume signal might sent be sent 1 ms prior to the start of a subsequent activity period instance, and/or one frame (e.g., one USB frame) prior to the start of a subsequent activity period instance.

Such resume signals might, for instance, be sent in the case where the host device and/or the connected device lacks its own clock, and/or in the case where clock drift is found to be unacceptable. For example, in the case where the host device has its own clock but the connected device does not, the host device might send such a resume signal to the connected device. As another example, in the case where the connected device has its own clock but the host device does not, the connected device might send such a resume signal to the host device.

As another example, the host device and/or the connected device might receive one or more such resume signals. Having received such a resume signal, the host device and/or the connected device might terminate one or more reduced energy consumption modes. Such termination might, for instance, be performed as discussed above.

Turning again to FIG. 3, it is noted that shown, for example, in FIG. 3 are exemplary reduced energy consumption mode aspects according to various embodiments of the present invention including, for instance, resume signal 307, termination 309 of one or more reduced energy consumption modes for host device and connected device hardware, subsequent activity period instance SOF 311, and subsequent activity period instance data 313.

### Multiple Device Operation

It is noted that, in various embodiments, a single device might be connected (e.g., via USB) to multiple devices. For example, the single device might be a host device of the sort discussed above and the multiple devices might be connected devices of the sort discussed above. As another example, the single device might be a connected device of the sort discussed above, and the multiple devices might be host devices of the sort discussed above. Connection might, for instance, be via a hub (e.g., via a USB hub). It is noted that, in various embodiments, connection might be provided such that there is one of the multiple devices per hub.

The single device might, for example, exchange data with the multiple devices such that within an activity period instance the single device exchanges data with each of the multiple devices. In various embodiments, a corresponding activity period specification might, perhaps in a manner analogous to that discussed above, have been sent to one or more of the multiple devices (e.g., via vendor-specific request).

As another example, the single device might selectively employ activity period instances in exchanging data with the multiple devices. For instance, the single device might exchange data with a first of the multiple devices during a first activity period instance, might exchange data with a second of the multiple devices during a second activity period instance, and/or might exchange data with a third of the multiple devices during a third activity period instance. It is noted that, in various embodiments, the first of the multiple devices might be connected via a first hub port, the second of the multiple devices might be connected via a second hub port, and/or the third of the multiple devices might be connected via a third hub port.

### Hardware and Software

Various operations and/or the like described herein may, in various embodiments, be executed by and/or with the help of computers. Further, for example, devices described herein may be and/or may incorporate computers. The phrases “computer,” “general purpose computer,” and the like, as used herein, refer but are not limited to a smart card, a media device, a personal computer, an engineering workstation, a PC, a Macintosh, a PDA, a portable computer, a computerized watch, a wired or wireless terminal, telephone, communication device, node, and/or the like, a server, a network access point, a network multicast point, a network device, a set-top box, a personal video recorder (PVR), a game console, a portable game device, a portable audio device, a portable media device, a portable video device, a television, a digital camera, a digital camcorder, a Global Positioning System (GPS) receiver, a wireless personal server, or the like, or any combination thereof, perhaps running an operating system such as OS X, Linux, Darwin, Windows CE, Windows XP, Windows Server 2003, Windows Vista, Palm OS, Symbian OS, or the like, perhaps employing the Series 40 Platform, Series 60 Platform, Series 80 Platform, and/or Series 90 Platform, and perhaps having support for Java and/or .Net.

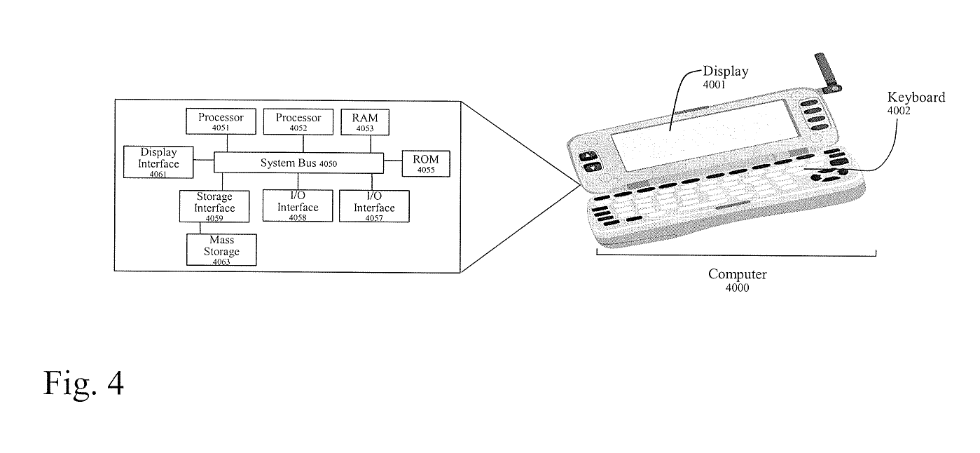

The phrases “general purpose computer,” “computer,” and the like also refer, but are not limited to, one or more processors operatively connected to one or more memory or storage units, wherein the memory or storage may contain data, algorithms, and/or program code, and the processor or processors may execute the program code and/or manipulate the program code, data, and/or algorithms. Shown in FIG. 4 is an exemplary computer employable in various embodiments of the present invention. Exemplary computer 4000 includes system bus 4050 which operatively connects two processors 4051 and 4052, random access memory 4053, read-only memory 4055, input output (I/O) interfaces 4057 and 4058, storage interface 4059, and display interface 4061. Storage interface 4059 in turn connects to mass storage 4063. Each of I/O interfaces 4057 and 4058 may, for example, be an Ethernet, IEEE 1394, IEEE 1394b, IEEE 802.11a, IEEE 802.11b, IEEE 802.11g, IEEE 802.11i, IEEE 802.11e, IEEE 802.11n, IEEE 802.15a, IEEE 802.16a, IEEE 802.16d, IEEE 802.16e, IEEE 802.16m, IEEE 802.16x, IEEE 802.20, IEEE 802.15.3, ZigBee (e.g., IEEE 802.15.4), Bluetooth (e.g., IEEE 802.15.1), Ultra Wide Band (UWB), Wireless Universal Serial Bus (WUSB), wireless Firewire, terrestrial digital video broadcast (DVB-T), satellite digital video broadcast (DVB-S), Advanced Television Systems Committee (ATSC), Integrated Services Digital Broadcasting (ISDB), Digital Multimedia Broadcast-Terrestrial (DMB-T), MediaFLO (Forward Link Only), Terrestrial Digital Multimedia Broadcasting (T-DMB), Digital Audio Broadcast (DAB), Digital Radio Mondiale (DRM), General Packet Radio Service (GPRS), Universal Mobile Telecommunications Service (UMTS), Global System for Mobile Communications (GSM), Code Division Multiple Access 2000 (CDMA2000), DVB-H (Digital Video Broadcasting: Handhelds), IrDA (Infrared Data Association), and/or other interface.

Mass storage 4063 may be a hard drive, optical drive, a memory chip, or the like. Processors 4051 and 4052 may each be a commonly known processor such as an IBM or Freescale PowerPC, an AMD Athlon, an AMD Opteron, an Intel ARM, a Marvell XScale, a Transmeta Crusoe, a Transmeta Efficeon, an Intel Xenon, an Intel Itanium, an Intel Pentium, an Intel Core, or an IBM, Toshiba, or Sony Cell processor. Computer 4000 as shown in this example also includes a touch screen 4001 and a keyboard 4002. In various embodiments, a mouse, keypad, and/or interface might alternately or additionally be employed. Computer 4000 may additionally include or be attached to one or more image capture devices (e.g., employing Complementary Metal Oxide Semiconductor (CMOS) and/or Charge Coupled Device (CCD) hardware). Such image capture devices might, for instance, face towards and/or away from one or more users of computer 4000. Alternately or additionally, computer 4000 may additionally include or be attached to card readers, DVD drives, floppy disk drives, hard drives, memory cards, ROM, and/or the like whereby media containing program code (e.g., for performing various operations and/or the like described herein) may be inserted for the purpose of loading the code onto the computer.

In accordance with various embodiments of the present invention, a computer may run one or more software modules designed to perform one or more of the above-described operations. Such modules might, for example, be programmed using languages such as Java, Objective C, C, C#, C++, Perl, Python, and/or Comega according to methods known in the art. Corresponding program code might be placed on media such as, for example, DVD, CD-ROM, memory card, and/or floppy disk. It is noted that any described division of operations among particular software modules is for purposes of illustration, and that alternate divisions of operation may be employed. Accordingly, any operations discussed as being performed by one software module might instead be performed by a plurality of software modules. Similarly, any operations discussed as being performed by a plurality of modules might instead be performed by a single module. It is noted that operations disclosed as being performed by a particular computer might instead be performed by a plurality of computers. It is further noted that, in various embodiments, peer-to-peer and/or grid computing techniques may be employed. It is additionally noted that, in various embodiments, remote communication among software modules may occur. Such remote communication might, for example, involve Simple Object Access Protocol (SOAP), Java Messaging Service (JMS), Remote Method Invocation (RMI), Remote Procedure Call (RPC), sockets, and/or pipes.

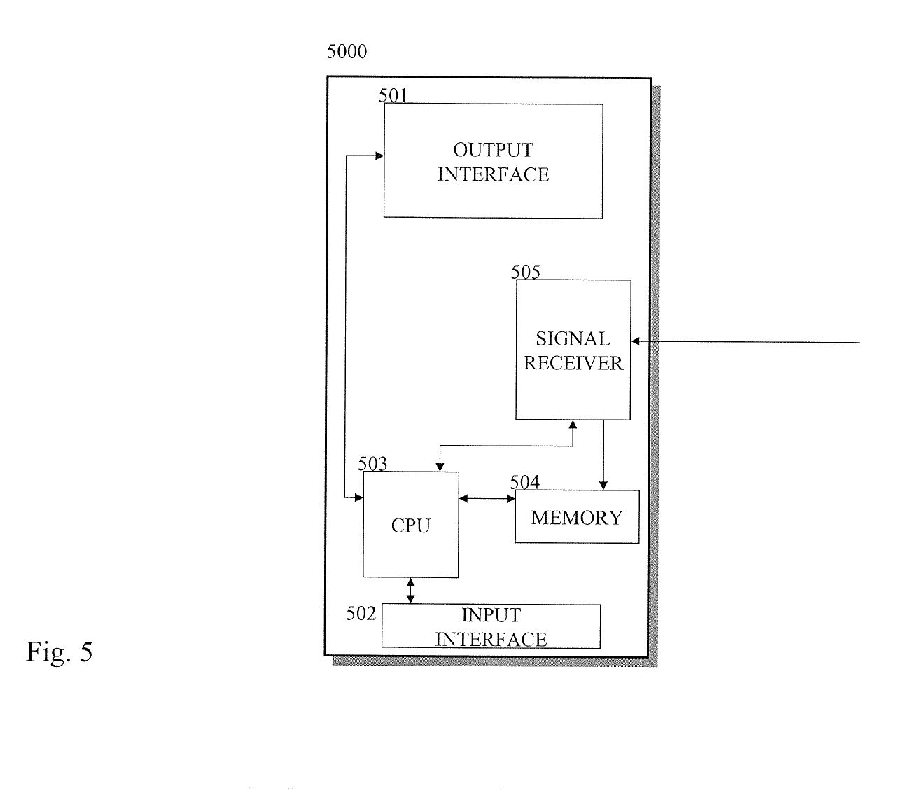

Shown in FIG. 5 is a block diagram of a terminal, an exemplary computer employable in various embodiments of the present invention. In the following, corresponding reference signs are applied to corresponding parts. Exemplary terminal 5000 of FIG. 5 comprises a processing unit CPU 503, a signal receiver 505, and a user interface (501, 502). Signal receiver 505 may, for example, be a single-carrier or multi-carrier receiver. Signal receiver 505 and the user interface (501, 502) are coupled with the processing unit CPU 503. One or more direct memory access (DMA) channels may exist between multi-carrier signal terminal part 505 and memory 504. The user interface (501, 502) comprises a display and a keyboard to enable a user to use the terminal 5000. In addition, the user interface (501, 502) comprises a microphone and a speaker for receiving and producing audio signals. The user interface (501, 502) may also comprise voice recognition (not shown).

The processing unit CPU 503 comprises a microprocessor (not shown), memory 504, and possibly software. The software can be stored in the memory 504. The microprocessor controls, on the basis of the software, the operation of the terminal 5000, such as receiving of a data stream, tolerance of the impulse burst noise in data reception, displaying output in the user interface and the reading of inputs received from the user interface. The hardware contains circuitry for detecting signal, circuitry for demodulation, circuitry for detecting impulse, circuitry for blanking those samples of the symbol where significant amount of impulse noise is present, circuitry for calculating estimates, and circuitry for performing the corrections of the corrupted data.

Still referring to FIG. 5, alternatively, middleware or software implementation can be applied. The terminal 5000 can, for instance, be a hand-held device which a user can comfortably carry. The terminal 5000 can, for example, be a cellular mobile phone which comprises the multi-carrier signal terminal part 505 for receiving multicast transmission streams. Therefore, the terminal 5000 may possibly interact with the service providers.

It is noted that various operations and/or the like described herein may, in various embodiments, be implemented in hardware (e.g., via one or more integrated circuits). For instance, in various embodiments various operations and/or the like described herein may be performed by specialized hardware, and/or otherwise not by one or more general purpose processors. One or more chips and/or chipsets might, in various embodiments, be employed. In various embodiments, one or more Application-Specific Integrated Circuits (ASICs) may be employed.

### RAMIFICATIONS AND SCOPE

Although the description above contains many specifics, these are merely provided to illustrate the invention and should not be construed as limitations of the invention's scope. Thus it will be apparent to those skilled in the art that various modifications and variations can be made in the system and processes of the present invention without departing from the spirit or scope of the invention.

In addition, the embodiments, features, methods, systems, and details of the invention that are described above in the application may be combined separately or in any combination to create or describe new embodiments of the invention.

What is claimed is:

1. A method, comprising:
sending, from a first device to a second device, a request, wherein the request specifies an activity period;
exchanging, within an instance of the activity period, data between the first device and the second device;
placing, subsequent to completion of the data exchange, communication hardware of the first device into one or more reduced energy consumption modes; and
terminating, in accordance with the activity period, the one or more reduced energy consumption modes,
wherein, while the communication hardware of the first device is in the one or more reduced energy consumption modes, energy use by the second device is permitted to be higher than a suspend mode energy use level.

2. The method of claim 1, further comprising sending, from the first device to the second device, a resume signal.

3. The method of claim 1, wherein the first device is connected to multiple devices, and wherein data is exchanged between the first device and the multiple devices within the instance of the activity period.

4. The method of claim 1, wherein the first device is connected to multiple devices, and wherein the first device selectively employs activity period instances in exchanging data with the multiple devices.

5. The method of claim 1, wherein at least a part of energy used by the second device is provided by the first device.

6. The method of claim 1, wherein hardware of the second device is placed into one or more reduced energy consumption modes subsequent to the completion of the data exchange.

7. The method of claim 1, wherein one or more reduced energy consumption modes corresponding to hardware of the second device are terminated in accordance with the activity period.

8. The method of claim 1, wherein the first device and the second device communicate via universal serial bus.

9. The method of claim 1, wherein the data exchange between the first device and the second device involves one or more of periodic transfer and non-periodic transfer.

10. A method, comprising:
receiving, from a first device at a second device, a request, wherein the request specifies an activity period;
exchanging, within an instance of the activity period, data between the second device and the first device;
placing, subsequent to completion of the data exchange, communication hardware of the second device into one or more reduced energy consumption modes, wherein energy use by the second device is permitted to be higher than a suspend mode energy use level; and
terminating, in accordance with the activity period, the one or more reduced energy consumption modes.

11. The method of claim 10, further comprising receiving, at the second device from the first device, a resume signal.

12. The method of claim 10, wherein the first device is connected to multiple devices, and wherein data is exchanged between the first device and the multiple devices within the instance of the activity period.

13. The method of claim 10, wherein the first device is connected to multiple devices, and wherein the first device selectively employs activity period instances in exchanging data with the multiple devices.

14. The method of claim 10, wherein at least a part of energy used by the second device is provided by the first device.

15. The method of claim 10, wherein communication hardware of the first device is placed into one or more reduced energy consumption modes subsequent to the completion of the data exchange.

16. The method of claim 10, wherein one or more reduced energy consumption modes corresponding to communication hardware of the first device are terminated in accordance with the activity period.

17. The method of claim 10, wherein the first device and the second device communicate via universal serial bus.

18. The method of claim 10, wherein the data exchange between the second device and the first device involves one or more of periodic transfer and non-periodic transfer.

19. An apparatus, comprising:
a memory having program code stored therein; and
a processor disposed in communication with the memory for carrying out instructions in accordance with the stored program code;
wherein the program code, when executed by the processor, causes the processor to perform:
sending, from the apparatus to a second apparatus, a request, wherein the request specifies an activity period;
exchanging, within an instance of the activity period, data with the second apparatus;
placing, subsequent to completion of the data exchange, communication hardware into one or more reduced energy consumption modes; and
terminating, in accordance with the activity period, the one or more reduced energy consumption modes,
wherein, while the communication hardware is in the one or more reduced energy consumption modes, energy use by the second apparatus is permitted to be higher than a suspend mode energy use level.

20. The apparatus of claim 19, wherein the processor further performs sending, to the second apparatus, a resume signal.

21. The apparatus of claim 19, wherein there is connection to multiple apparatuses, and wherein data is exchanged with the multiple apparatuses within the instance of the activity period.

22. The apparatus of claim 19, wherein there is connection to multiple apparatuses, and wherein activity period instances are selectively employed in exchanging data with the multiple apparatuses.

23. The apparatus of claim 19, wherein the processor further performs providing to the second apparatus at least a part of energy used by the second apparatus.

24. The apparatus of claim 19, wherein hardware of the second apparatus is placed into one or more reduced energy consumption modes subsequent to the completion of the data exchange.

25. The apparatus of claim 19, wherein one or more reduced energy consumption modes corresponding to hardware of the second apparatus are terminated in accordance with the activity period.

26. The apparatus of claim 19, wherein communication with the second apparatus is carried out via universal serial bus.

27. The apparatus of claim 19, wherein the data exchange involves one or more of periodic transfer and non-periodic transfer.

28. An apparatus, comprising:
a memory having program code stored therein; and
a processor disposed in communication with the memory for carrying out instructions in accordance with the stored program code;
wherein the program code, when executed by the processor, causes the processor to perform:
receiving, at the apparatus from a second apparatus, a request, wherein the request specifies an activity period;
exchanging, within an instance of the activity period, data with the second apparatus;
placing, subsequent to completion of the data exchange, communication hardware into one or more reduced energy consumption modes, wherein energy use is permitted to be higher than a suspend mode energy use level; and
terminating, in accordance with the activity period, the one or more reduced energy consumption modes.

29. The apparatus of claim 28, wherein the processor further performs receiving from the second apparatus, a resume signal.

30. The apparatus of claim 28, wherein the second apparatus is connected to multiple apparatuses, and wherein data is exchanged between the second apparatus and the multiple apparatuses within the instance of the activity period.

31. The apparatus of claim 28, wherein the second apparatus is connected to multiple apparatuses, and wherein the second apparatus selectively employs activity period instances in exchanging data with the multiple apparatuses.

32. The apparatus of claim 28, wherein at least a part of energy used is provided by the second apparatus.

33. The apparatus of claim 28, wherein hardware of the second apparatus is placed into one or more reduced energy consumption modes subsequent to the completion of the data exchange.

34. The apparatus of claim 28, wherein one or more reduced energy consumption modes corresponding to hardware of the second apparatus are terminated in accordance with the activity period.

35. The apparatus of claim 28, wherein communication with the second apparatus is carried out via universal serial bus.

36. The apparatus of claim 28, wherein the data exchange involves one or more of periodic transfer and non-periodic transfer.

37. An article of manufacture comprising a computer readable medium containing program code that when executed causes an apparatus to perform:
sending, from the apparatus to a second apparatus, a request, wherein the request specifies an activity period;
exchanging, within an instance of the activity period, data with the second apparatus;
placing, subsequent to completion of the data exchange, communication hardware into one or more reduced energy consumption modes; and
terminating, in accordance with the activity period, the one or more reduced energy consumption modes,
wherein, while the communication hardware is in the one or more reduced energy consumption modes, energy use by the second apparatus is permitted to be higher than a suspend mode energy use level.

38. An article of manufacture comprising a computer readable medium containing program code that when executed causes an apparatus to perform:
receiving, at the apparatus from a second apparatus, a request, wherein the request specifies an activity period;
exchanging, within an instance of the activity period, data with the second apparatus;
placing, subsequent to completion of the data exchange, communication hardware into one or more reduced energy consumption modes, wherein energy use is permitted to be higher than a suspend mode energy use level; and
terminating, in accordance with the activity period, the one or more reduced energy consumption modes.
